(19) United States
(12) Patent Application Publication
(10) Pub. No.: US 2014/0003655 A1
(43) Pub. Date: Jan. 2, 2014

(54) METHOD, APPARATUS AND SYSTEM FOR PROVIDING IMAGE DATA TO REPRESENT INVENTORY

(71) Applicants: Praveen Gopalakrishnan, Hillsboro, OR (US); Victor B. Lortz, Beaverton, OR (US); William J. Colson, Hillsboro, OR (US); Bradley W. Corrion, Chandler, AZ (US); Xingang Guo, Portland, OR (US)

(72) Inventors: Praveen Gopalakrishnan, Hillsboro, OR (US); Victor B. Lortz, Beaverton, OR (US); William J. Colson, Hillsboro, OR (US); Bradley W. Corrion, Chandler, AZ (US); Xingang Guo, Portland, OR (US)

(21) Appl. No.: 13/538,774

(22) Filed: Jun. 29, 2012

(51) Int. Cl. G06K 9/46

(52) U.S. Cl. 382/103; 382/195

(57) ABSTRACT

Techniques and mechanisms for generating image data representing a storage region in a commercial establishment. In an embodiment, image recognition analysis of first image data detects a difference between respective states of inventory storage represented by different areas of a captured image. In another embodiment, other image data is generated to represent a modified version of the image, wherein, based on the detected difference, a filter is applied to only one two portions of the first image data.

### BACKGROUND

1. Technical Field

Embodiments relate generally to techniques for generating image data based on an image of an inventory storage region. More particularly, certain embodiments filter a portion of image data based on a state of inventory storage represented in a captured image.

2. Background Art

Improvements in inventory and/or supply chain information systems have allowed for stakeholders (e.g. manufacturers, parts suppliers, distributers, wholesalers, retailers, employees, etc.) to more closely track the state of inventory storage in commerce. As the size and sophistication of these information systems continue to grow, increasingly large scale, complex, timely, and/or granular information describing inventory storage state is generated and aggregated.

The dissemination of such information allows for faster and more precise mechanisms for a stakeholder to detect and respond to inefficiencies in inventory distribution and/or storage. Conversely, there is an increasing premium placed on limiting access to such information, as improvements in operational efficiency become incrementally more critical for stakeholders to remain competitive.

Inventory imaging is one increasingly common source of inventory state information. Conventional inventory imaging techniques typically include a stakeholder sending personnel to a retail store to manually capture digital images of inventory which is currently in storage. However, such manual collecting of image data is costly, slow, subject to human error and generally of interest only to the stakeholder performing such collecting. As greater value is placed on inventory monitoring, the limitations of existing inventory imaging techniques become more constraining on the effectiveness of information systems in commerce.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating elements of a system for providing image data to represent inventory according to an embodiment.

FIG. 2 is a block diagram illustrating elements of a server system to provide image data according to an embodiment.

FIG. 3 is a flow diagram illustrating elements of a method for providing image data according to an embodiment.

FIG. 4 is a block diagram illustrating elements of a message to be accessed for generating image data according to an embodiment.

FIG. 5 is a block diagram illustrating elements of rule information to be accessed for generating image data according to an embodiment.

FIGS. 6A through 6E are block diagrams illustrating elements of respective images represented by image data provided according to various embodiments.

FIG. 7 is a block diagram illustrating elements of a computer platform for providing image data according to an embodiment.

### DETAILED DESCRIPTION

Embodiments discussed herein variously provide image data to represent a state of inventory storage in a commercial establishment. Such image data may, for example, be automatically generated based on other image data representing a captured image of a storage region (e.g. a shelf, display stand, refrigerator, clothing rack and/or the like). The generated image data may represent a modified version of the captured image, in which some area of the original captured image is filtered (e.g. blurred, masked, cropped and/or the like).

At least one advantage provided by various embodiments is that a commercial stakeholder may identify from the modified version of the image a state of inventory storage which is relevant to or otherwise associated with that stakeholder. In certain embodiments, that same commercial stakeholder may be prevented from identifying in the modified image another state of inventory storage which, for example, is associated with a competing stakeholder.

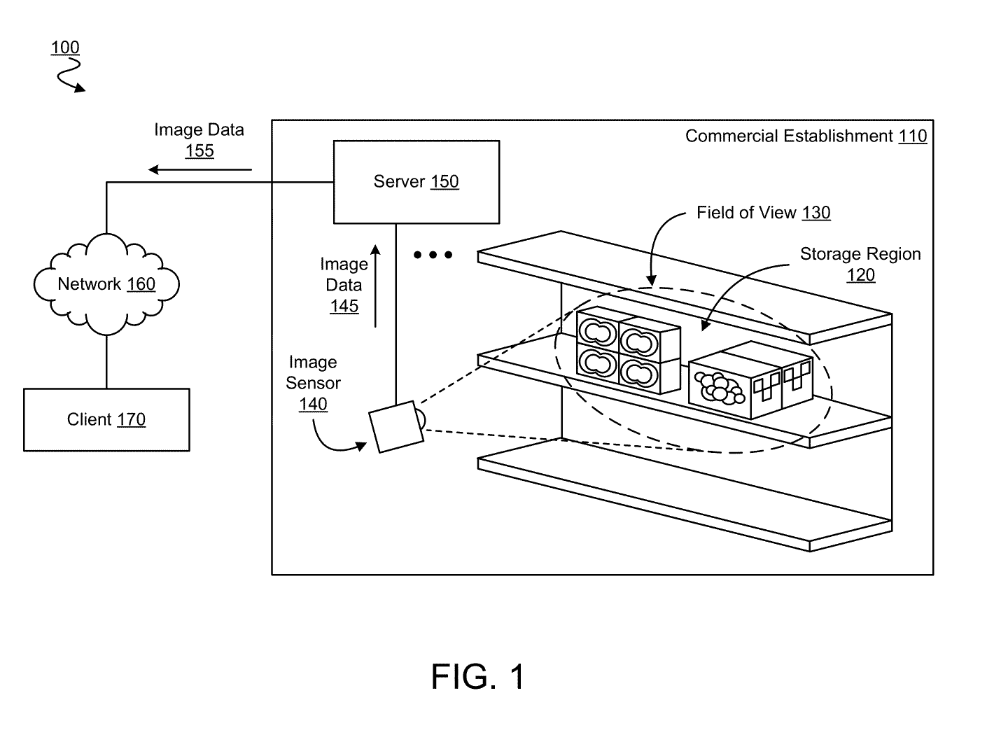

FIG. 1 illustrates elements of a system 100 for providing, according to an embodiment, image data representing a captured image of some inventory. To illustrate certain features of different embodiments, some elements of system 100 are shown in relation to a commercial establishment 110. However, commercial establishment 110 itself may not be included in system 100, in certain embodiments.

Commercial establishment 110 may serve for the conducting of some commerce—e.g. where commercial establishment 110 includes a store, distribution warehouse, mall or any of a variety of other such establishments for the exchange of commercial goods. By way of illustration and not limitation, commercial establishment 110 may include one or more of a grocery store, a clothing store, a department store, a big box store, an outlet store and/or the like.

Commercial establishment 110 may include one or more storage regions, represented by an illustrative storage region 120. Storage region 120 may include one or more shelves, display stands, refrigerators, clothing racks, and/or other locations where inventory may be stored. By way of illustration and not limitation, storage region 120 may include one or more regions which are in a floor area accessible by regular customer foot traffic. Alternatively or in addition, storage region 120 may include one or more stocking regions which are intended for access only by employees working in commercial establishment 110.

As shown in FIG. 1, the illustrative storage region 120 includes part of one shelf in a storage rack. However, storage region 120 may include any of a variety of additional or alternative storage regions. For example, storage region 120 may include multiple component sub-regions which are not contiguous with one another, although certain embodiments are not limited in this regard.

System 100 may include one or more image sensors to capture an image describing a state of inventory storage in commercial establishment 110. By way of illustration and not limitation, system 100 may include an image sensor 140—i.e. any of a variety of devices including circuit logic, optics and/or other hardware to capture an image of storage region 120 and to provide image data 145 representing that captured image. Image sensor 140 may, for example, include a camcorder, dedicated digital camera, surveillance video camera, laptop computer, handheld computer (such as a palmtop, tablet device, etc.) smart phone or other device which includes image sensing functionality.

In an embodiment, image sensor 140 is mounted in or on a storage region, wall, pillar, ceiling or other such structure of commercial establishment 110. Image sensor 140 may be configured—e.g. manually or remotely—to automatically perform one or more image capture operations.

By way of illustration and not limitation, image sensor 140 may be configured to capture an image while in a first state, in which storage region 120 is within a field of view 130 of image sensor 140. Image sensor 140 may be operable to capture one or more images in any of a variety of additional or alternative states, according to different embodiments. For example, image sensor 140 may be at least partially movable—e.g. with a gimbal, track, cable suspension system and/or other such means—and/or remotely operable to have one or more of a position, orientation, pan, zoom, focus, etc. for being in the first state. While in the first state, image sensor 140 may automatically respond to a signal indicating that an image is to be captured. In an alternate embodiment, image sensor 140 is a handheld or otherwise mobile device which is carried and/or operated manually—e.g. by an employee, customer, stakeholder's representative, etc.

In an embodiment, image sensor 140 communicates image data 145 representing a captured image of storage region 120. Image data 145 may comprise any of a variety of still and/or motion image data formats including, but not limited to, one or more of JPEG, GIF, TIFF, MPEG, bitmap and/or the like. System 100 may include logic—e.g. including hardware, firmware and/or executing software—to provide an at least partially filtered version of image data 145.

For example, one or more computer platforms of system 100 may include, or otherwise have access to, circuit logic to provide image recognition analysis of image data 145. Additionally or alternatively, such one or more computer platforms may include circuit logic to apply an image filter to image data 145—e.g. based upon information describing an output of such image recognition analysis.

By way of illustration and not limitation, system 100 may include one or more servers—represented by an illustrative server 150—to automatically generate image data 155 based on image data 145. Generating image data 155 may include one or more operations to filter—e.g. remove or modify—at least some of image data 145. Such filtering may, for example, be based on image recognition analysis of image data 145.

In an embodiment, image recognition logic of server 150 may analyze image data 145 to identify, for each of one or more areas of the image, a respective state of inventory storage represented by that area. As used herein, “state of inventory storage” refers to a state of whether and/or how some inventory is stored (or not stored). Identification of a state of inventory storage may include, for example, specifying a type of product represented in at least some area of an image. A product type may be specified with one or more of a serial number or other product-specific identifier, an identifier of a manufacturer of the product, an identifier of a distributer of the product, an identifier of a component of the product (and/or the components supplier or distributor), any of a variety of generic classifications of the product (e.g. food, beverage, hardware, computer, etc.) and/or the like. Alternatively or in addition, identification of a state of inventory storage may include describing a count of items of the product type, a position, orientation or other storage condition of one such item and/or any of a variety of other characteristics of stored inventory. In an embodiment, a state of inventory storage includes a condition of stored inventory being opened, damaged, dirty or otherwise flawed.

Image recognition logic of server 150 may include, or otherwise have access to, a database or other source of reference information which describes respective features of one or more product types. Such features may, for example, include one or more dimensions, a shape, a barcode, a trademark, a color, an ornamental pattern and/or the like. Based on such reference information, image recognition analysis of image data 145 may indicate that a feature of a particular area of the corresponding image corresponds to a feature corresponding to a particular product type. In response to such image recognition analysis, image evaluation logic of server 150 may generate an output specifying or otherwise indicating an association of that area of the image with the particular product type.

In an embodiment, automatic generation of image data 155 is based at least in part on analysis of image data 145 indicating that some first area of the image represented by image data 145 and some second area of that same image represent different respective states of inventory storage. By way of illustration and not limitation, image recognition analysis may detect that the first area of the image includes an indication of some first product type. Such an indication may include one or more of a dimension, shape, barcode, trademark, color, ornamental pattern and/or other feature of a stored inventory item. Alternatively or in addition, such an indication may include a marker—e.g. a barcode, signage and/or other printing—to represent the first product type, where the marker is located on a shelf, rack, display stand or other structure of the storage region.

The image recognition analysis may further detect that the second area of the image includes an indication of some second product type which is different than the first product type. Alternatively, such image recognition analysis may detect that the second area of the image fails to include any indication of the first product type, or may otherwise fail to detect any indication of the first product type in the second area of the image. Based on such detecting by the image recognition analysis, server 150 may identify a difference in states of inventory storage and, based on such identifying, determine whether and/or how a filter may be applied to some portion of image data 145 for the purpose of generating image data 155.

Filtering of some portion of image data 145 may be based at least on information describing an intended viewer of the modified version of the captured image. For example, such filtering may be based on a particular client 170 which is to be sent image data 155. For example, image filter logic of server 150 may include, or otherwise have access to, a database or other source of reference information which identifies a rule for an entity—e.g. a commercial entity—on whose behalf which client 170 operates, at least in part. Based on an identification of the rule, the image filter logic may apply a filter to prevent or limit the representation of some feature in a modified version of the image captured by image sensor 140. Such a feature may, for example, describe a state of inventory storage with respect to a product made by, distributed by, or otherwise associated with another entity which engages in commerce with or through commercial establishment 110. The resulting image data 155 may then be communicated to client 170. In an embodiment, image data 155 is communicated via a network 160 comprising any of a variety of combinations of one or more public and/or private networks including, but not limited to, a local area network (LAN), a virtual LAN (VLAN), a wide area network (WAN), a cloud network, an Internet and/or the like.

To illustrate certain features of various embodiments, filtering of image data is discussed herein with respect to a client which is to be sent resulting image data. However, the filtering of some portion of image data 145, or other similar data, may be based on any of a variety of additional or alternative descriptions of an intended viewer. For example, image data filtering may be performed based on an identifier, a role, a credential and or other descriptor of a person (e.g. an employee) or group of persons and/or the like who are an intended target for receiving filtered image data.

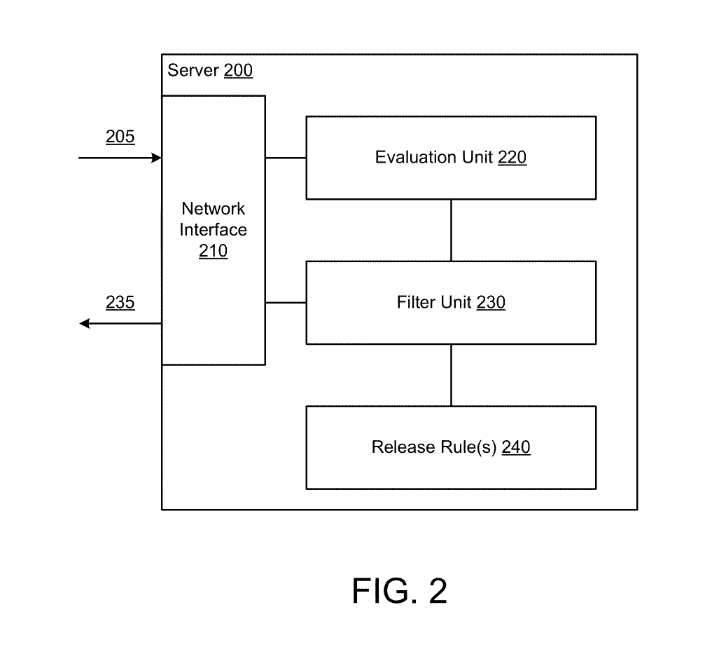

FIG. 2 illustrates elements of a server 200 for providing image data according to an embodiment. Server 200 may include a computer platform for operation in a system such as system 100. For example, server 200 may include a computer platform to provide some or all of the functionality of server 150. In an alternate embodiment, such functionality may be distributed across multiple computer platforms—e.g. in a tiered server network.

Server 200 may be located, for example, in commercial establishment 110 or other such location for conducting commerce. In an alternate embodiment, at least some of the functionality of server 200 may be remote from, and networked with, an image sensor device, computer and/or other source of image data located in such an establishment.

Server 200 may include a network interface 210 to receive a message 205 comprising image data representing a captured image of a storage region. Such image data may, for example, include some or all of the features of image data 145. Additionally or alternatively, server 200 may include an evaluation unit 220 comprising logic—e.g. hardware, firmware and/or executing software—to evaluate in response to message 205 whether a difference of inventory storage states is indicated by the image data. For example, evaluation unit 220 may identify a state of inventory storage of a first area of the captured image—e.g. where evaluation unit 220 detects that the first area includes an indication of a first product type. Evaluation unit 220 may further detect that a second area of the same captured image represents a state of inventory storage which is different from that of the first area. For example, evaluation unit 220 may detect that the second area includes an indication of a second product type different from the first product type. Alternatively or in addition, evaluation unit 220 may detect a failure to identify the second area as representing the same state of inventory storage as that of the first area.

By way of illustration and not limitation, evaluation unit 220 may comprise image recognition logic to perform an analysis of the image data representing the captured image. Such image recognition logic may include, or otherwise have access to, a database or other source of reference information (not shown) which describes respective features of one or more product types. Based on such reference information, image recognition logic of server 200 may identify some first product type as corresponding to a feature in some first area of the captured image. In an embodiment, such image recognition logic may further identify that some second product type corresponds to a feature in a second area of the captured image. Alternatively or in addition, such image recognition logic may identify a failure to find any correspondence of the first product type with such a second area of the captured image

In certain embodiments, such image recognition logic is located outside of server 200 and is to send a result of image recognition analysis to server 200. For example, such a result may be sent as metadata which is included in message 205 itself or, in another embodiment, as a response to server 200 requesting analysis of the image data in the received message 205.

Server 200 may further include a filter unit 230 which includes logic to automatically generate second image data representing a modified version of the captured image represented in message 205. In an embodiment, generation of such second image data includes applying a filter to some portion of the image data representing the captured image. Application of such an image filter may, for example, be based on the difference of inventory storage states detected by evaluation unit 220. By way of illustration and not limitation, server 200 may include, or otherwise have access to, one or more release rules 240 or other such reference information which describes one or more conditions under which certain types of information may—or may not—be represented in image data which is to be released.

In response to evaluation unit 220 detecting the difference of inventory storage states, filter unit 230 may access the one or more release rules 240 to determine whether or how a filter is to be applied to some portion of the image data in message 205. For example, of a first portion of the image data for a first area of the captured image and a second portion of the image data for a second area of the captured image, filter unit 230 may, based on a difference of the respective inventory storage states represented by the first area and second area, apply a filter to only one of the first portion and second portion. The filter may be further applied to one or more other portions of the image data on some other basis, although certain embodiments are not limited in this regard.

In an embodiment, server 200 sends a message 235 which includes the second image data generated by filter unit 230. The second image data may, for example, provide a modified version of the captured image which includes a blurred representation of some area—e.g. the second area—in that captured image. In another embodiment, the modified version of the captured image may include a masked representation of such an area in the captured image. In still another embodiment, the modified version of the captured image may omit any representation of such an area in the captured image.

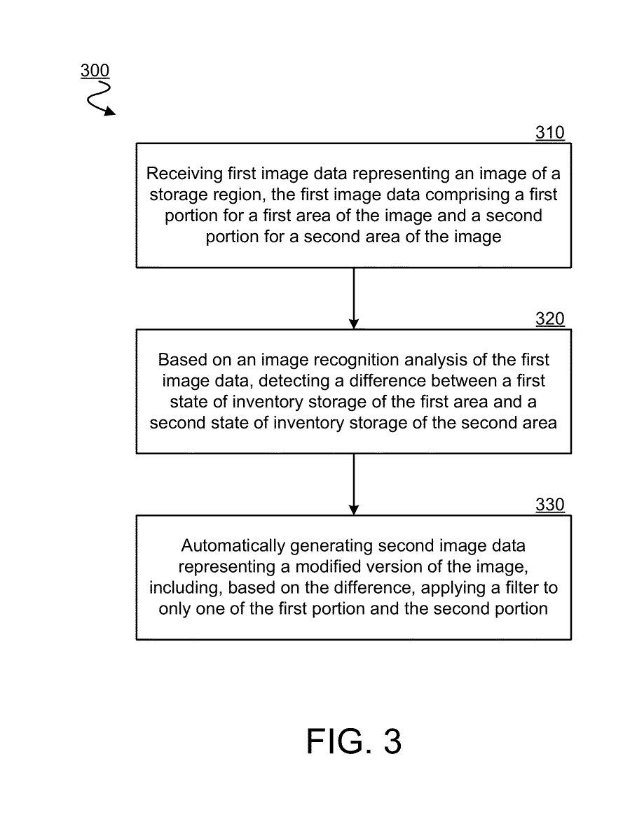

FIG. 3 illustrates elements of a method 300 for providing image data according to an embodiment. Method 300 may be performed by a system having some or all of the features of server 150. For example, method 300 may be performed by server 200. In an embodiment, method 300 includes, at 310, receiving first image data representing an image of a storage region. The first image data may comprise a first portion for a first area of the image and a second portion for a second area of the image.

Based on image recognition analysis of the first image data received at 310, method 300 may, at 320, detect a difference between a first state of inventory storage of the first area and a second state of inventory storage of the second area. In an embodiment, the detecting at 320 includes detecting, based on image recognition information, that the first area includes an indication of a first product type and that the second area does not include any indication of the first product type. In another embodiment, the detecting at 320 includes detecting, based on image recognition information, a failure of image recognition analysis to specify a state of inventory storage which is specific to the second area. In still another embodiment, the detecting at 320 includes detecting, based on image recognition information, that the first area includes an indication of a first product type and that the second area includes an indication of a second product type. The detecting at 320 may be further based on a release rule indicating a conflict between the first product type and the second product type. The conflict may, for example, include a conflict between a first commercial entity associated with the first product type and a second commercial entity associated with the second product type.

Method 300 may further include, at 330, automatically generating second image data representing a modified version of the image. In an embodiment, the generating at 330 includes applying a filter, based on the difference detected at 320, to only one of the first portion of the image data and the second portion of the image data.

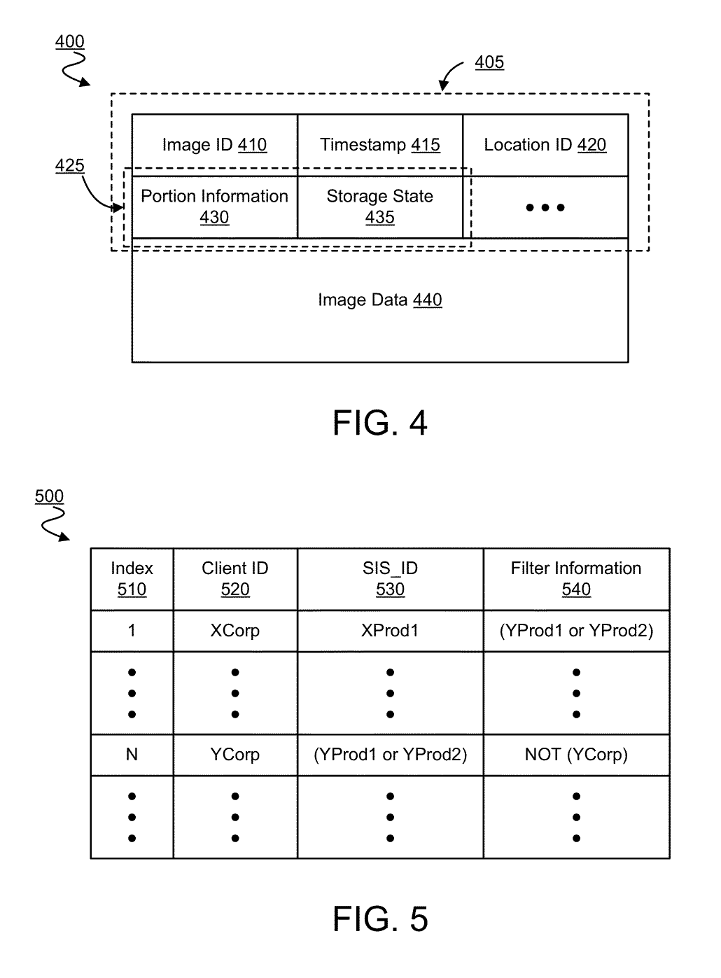

FIG. 4 illustrates elements of a message 400 for generating image data according to an embodiment. Message 400 may include some or all of the features of message 205, for example. In an embodiment, message 400 includes image data 440 representing a captured image of a storage region such as one located in a commercial establishment. Image data 440 may, for example, include some or all of the features of image data 145.

The captured image may include an indication of a state of inventory storage in such a storage region. For example, image data 440 may include a first portion for a corresponding first area of the captured image and a second portion for a corresponding second area of the captured image. The first area may include an indication of a first state of inventory storage—e.g. with respect to a first product type—and the second area may include an indication of a second state of inventory storage.

In an embodiment, message 400 further includes metadata 405 describing or otherwise associated with image data 440. By way of illustration and not limitation, metadata 405 may include one or more of an image identifier 410 to be used in referencing image data 440, a timestamp 415 describing a time when the image represented by image data 440 was captured, a location identifier 420 describing a location of the image sensor which generated image data 440 and/or a location of a storage region shown in the captured image. However, the information shown in metadata 405 is merely illustrative, and it not limiting on certain embodiments. Any of a variety of additional or alternative information may be included in metadata 405.

Various embodiments may apply image recognition analysis of image data 440 to automatically generate some other image data representing a modified version of the captured image. By way of illustration and not limitation, metadata 405 may include first image recognition information 425 representing a result of such image recognition analysis. First image recognition information 425 may include a result of an analysis of some first portion of the image data 440. For example, first image recognition information 425 may describe a first state of inventory storage indicated in a first area in the captured image.

In an illustrative embodiment, first image recognition information 425 includes portion information 430 specifying the first portion of image data 440. Specifying the first portion of image data 440 may, for example, include portion information 430 identifying a group of pixels, data bytes and/or the like which are included in and/or define a boundary of the first area. First image recognition information 425 may further include storage state 435 corresponding to portion information 430. In an embodiment, storage data 435 includes information describing the state of inventory storage of the first area which has been determined by image recognition analysis.

Message 400 may include similar image recognition information (not shown) for one or more other portions of image data 440, in various embodiments. For example, metadata 405 may include second image recognition information for a second portion of image data 440, the second image recognition information describing a state of inventory storage indicated in a second area of the captured image. Such second image recognition information may, for example, include component information similar to portion information 430 and/or storage state 435.

In an alternate embodiment, message 400 does not include image recognition information which is the result of image recognition analysis of image data 440. For example, message 400 may be provided to some logic which is to perform image recognition analysis of image data 440. The result of such image recognition analysis may be used to automatically generate image recognition information such as that shown in FIG. 4. In an embodiment, such image recognition information may be appended as metadata for message 400, or otherwise associated with message 400—e.g. for subsequent access by some image filter logic such as filter unit 230.

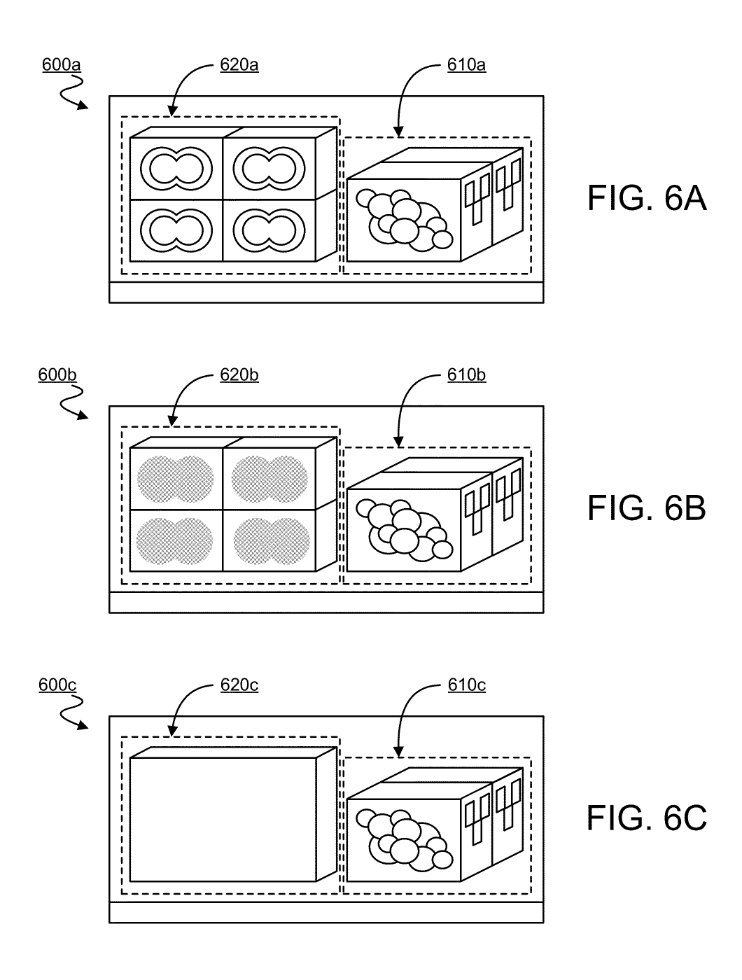

FIG. 5 illustrates elements of release rules 500 for use in processing image data according to an embodiment. Release rules 500 may be accessed—e.g. by filter unit 230 or other such logic—as reference information for determining whether and/or how a filter is to be applied to some portion of image data. For example, release rules 500 may include some or all of the features of one or more release rules 240.

The information of release rules 500 may, for example, be stored in a table, database and/or any of a variety of other data structures. Additionally or alternatively, information of release rules 500 may be distributed across multiple such data structures. In an embodiment, release rules 500 may include an index 510—e.g. a field in a table entry or other such data portion—for use in addressing or otherwise identifying a particular one of release rules 500. To demonstrate certain features of different embodiments, release rules 500 are shown as including N or more rules, with illustrative information in rules 1 and N. However, release rules 500 may include any of a variety of one or more additional or alternative rules.

In an embodiment, a given rule of release rules 500 may include information to associate a state of inventory storage with a type of image data to be filtered. Such a rule may further include or otherwise reference an indication of an entity which is to receive image data resulting from such filtering.

By way of illustration and not limitation, some or all of release rules 500 may each include a respective client identifier 520 to specify a particular client and/or an entity associated with such a client. Additionally or alternatively, some or all of release rules 500 may each include a respective identifier SIS_ID 530 of a state of inventory storage—e.g. where a value of SIS_ID 530 for a given rule indicates an applicability of that particular rule for some image processing. Additionally or alternatively, some or all of release rules 500 may each include respective filter information 540 indicating a test condition for applying an image filter, a particular filter type to be applied and/or the like.

In an illustrative embodiment, a value for SIS_ID 530 in Rule 1 may specify or otherwise indicate that filtering according to Rule 1 is to be applied where image recognition analysis has determined that a product XProd1 is represented in some area of a captured image. Alternatively or in addition, a value for SIS_ID 530 in Rule N may specify or otherwise indicate that filtering according to Rule N is to be applied where image recognition analysis has determined that product YProd1 or product YProd2 is represented in some area of a captured image.

Furthermore, a value for client ID 520 in Rule 1 may, for example, specify that some entity XCorp is (or is associated with) a client which is to receive image data which results from image filtering. Alternatively or in addition, a value for client ID 520 in Rule N may specify, for example, that some entity YCorp is (or is associated with) a client which is to receive image data which results from image filtering.

Further still, filter information 540 for Rule 1 may, for example, specify that filtering is to be applied to any portion of image data for which a corresponding area of the captured image represents storage of product YProd1 and/or storage of product YProd2. Alternatively or in addition, filter information 540 for Rule N may, for example, specify that filtering is to be applied to any portion of image data for which a corresponding area of the captured image does not represent storage of a product made by YCorp.

Image filtering according to one embodiment is discussed herein with reference to an illustrative scenario which includes utilizing message 400 and release rules 500. However, any of a variety of other messages and release rules may be similarly utilized, according to different scenarios and/or embodiments.

In the illustrative scenario, evaluation unit 220 may identify, based on a result of image recognition analysis, that an area of an image represents a state of inventory storage which includes storage of product XProd1. Identifying the inventory storage state may, for example, include evaluation unit 220 accessing storage state 435 of message 400, or determining such state information in response to receiving message 400.

Based on product XProd1 being represented in the identified inventory storage state, filter unit 230 may search SIS_ID 530 information of release rules 500. Such a search may identify that Rule 1 is to be applied for processing of image data 440. In response to identifying the applicability of Rule 1, filter unit 230 or some other logic of server 200 may identify from information in client ID 520 for Rule 1 that a particular client operating on behalf of XCorp is to receive image data which results from filter processing of image data 440 according to Rule 1. Alternatively or in addition, filter unit 230 may, based on filter information 540 for Rule 1, apply a filter to any portion of image data 440 which image recognition analysis indicates represents storage of product YProd1 or storage of product YProd2 (for example, storage of both YProd1 and YProd2).

By way of illustration and not limitation, evaluation unit 220 may detect an indication that some other area of the same image does not represent the same inventory storage state—i.e. does not represent storage of XProd1. For example, evaluation unit 220 may detect that some other area of the captured image represents storage of YProd1 or YProd2, or detect a failure of image recognition analysis to identify the other area as representing storage of XProd1. Based on the difference in the respective inventory storage states of the two image areas, a filter may be applied to a portion of image data 440 for only one of the two image areas.

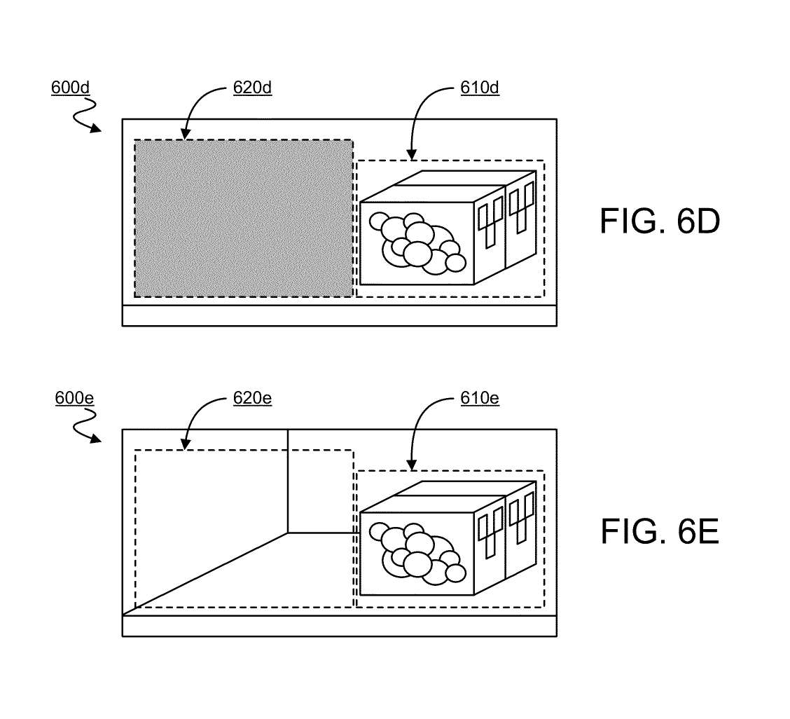

FIG. 6A shows certain features of an image 600a of a storage region in a commercial establishment. For example, image 600a may include a representation of storage region 120, although certain embodiments are not limited in this regard. In an embodiment, data such as image data 440 for representing image 600a may be processed to automatically generate other image data to be provided to some client.

For example, image recognition analysis of image data for image 600a may identify a first area 610a of image 600a as representing a first state of inventory storage. The identified first inventory storage state may include the storage of a first product type—e.g. where an illustrative two items of the first product type are represented in first area 610a. Alternatively or in addition, such image recognition analysis may identify a second area 620a of image 600a as representing a second state of inventory storage. The identified inventory storage state of second area 620a may include storage of a second product type—e.g. where an illustrative four items of the second product type are represented in second area 620a. In an alternate embodiment, the results of such image recognition analysis may omit characterization of any inventory storage state for second area 620a.

Based on such image recognition analysis, processing of first image data representing image 600a may be performed to generate second image data for a particular client or clients, the second image data representing a modified version of image 600a. Generating such second image data may include applying a filter to a portion of the first image data based on the detected difference between respective inventory storage states for areas 610a and 620a. In an embodiment, the filter is applied—based on the difference—to only one of a portion of the first image data which corresponds to first area 610a and a portion of the first image data which corresponds to second area 620a.

FIGS. 6B-6E shows certain features of various modified versions of image 600a according to different embodiments. FIG. 6B show an image 600b comprising a first area 610b corresponding to first area 610a and a second area 620b corresponding to second area 620a. Image 600b may be represented by image data, the generation of which includes applying a filter to a portion of image data which describes second area 620a. In the case of image 600b, the filter is applied to fade, blur, scramble or otherwise obscure some barcode, trademark, color, ornamental pattern and/or other graphical feature of one or more items represented in second area 620a.

FIG. 6C show an image 600c comprising a first area 610c corresponding to first area 610a and a second area 620c corresponding to second area 620a. Image 600c may be represented by image data, the generation of which includes applying a filter to a portion of image data which describes second area 620a. In the case of image 600c, the filter is applied to remove or otherwise obscure one or more visual elements which distinguish one stored item from another stored item.

FIG. 6D show an image 600d comprising a first area 610d corresponding to first area 610a and a second area 620d corresponding to second area 620a. Image 600d may be represented by image data, the generation of which includes applying a filter to a portion of image data which describes second area 620a. In the case of image 600d, the filter is applied to mask second area 620a—e.g. by setting all pixels in second area 620d to some single color value.

FIG. 6E show an image 600e comprising a first area 610e corresponding to first area 610a and a second area 620e corresponding to second area 620a. Image 600e may be represented by image data, the generation of which includes applying a filter to a portion of image data which describes second area 620a. In the case of image 600e, the filter is applied to substitute the representation in second part 620a with a representation of some other image portion—e.g. a representation of an empty portion of a storage shelf.

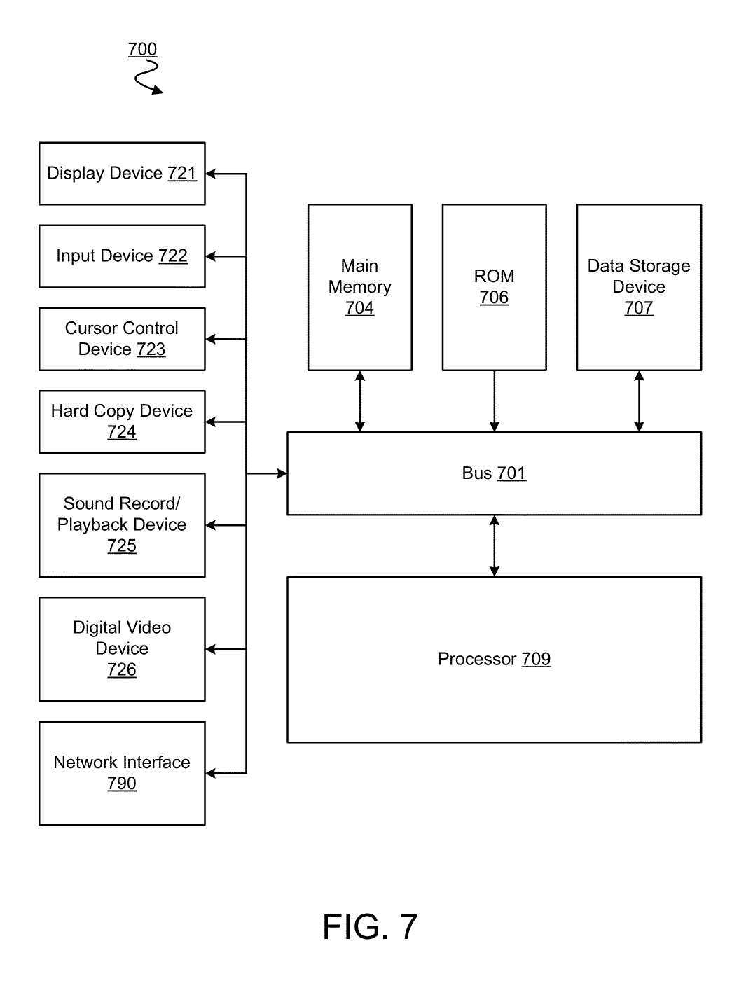

FIG. 7 shows elements of an illustrative communication device 700 for providing image data according to one embodiment. Computer platform 700 may include some or all of the features of server 150, for example. Alternatively or in addition, computer platform 700 may include some or all of the features of server 200.

In an embodiment, computer platform 700 includes a hardware platform capable of contributing to the providing of a service over a network. Computer platform 700 may, for example, include a server, desktop computer, laptop computer, a handheld computer—e.g. a tablet, palmtop, smart phone, media player, and/or the like—a gaming console, set-top box and/or other such computer system. In an embodiment, computer platform 700 includes functionality to operate as a cloud computing node to contribute the providing of image data according to techniques discussed herein.

In an embodiment, computer platform 700 includes at least one interconnect, represented by an illustrative bus 701, for communicating information and a processor 709—e.g. a central processing unit—for processing image data. Processor 709 may include functionality of a complex instruction set computer (CISC) type architecture, a reduced instruction set computer (RISC) type architecture and/or any of a variety of processor architecture types. Processor 709 may couple with one or more other components of computer platform 700 via bus 701. By way of illustration and not limitation, computer platform 700 may include a random access memory (RAM) or other dynamic storage device, represented by an illustrative main memory 704 coupled to bus 701, to store information and/or instructions to be executed by processor 709. Main memory 704 also may be used for storing temporary variables or other intermediate information during execution of instructions by processor 709. Computer platform 700 may additionally or alternatively include a read only memory (ROM) 706, and/or other static storage device—e.g. where ROM 706 is coupled to processor 709 via bus 701—to store static information and/or instructions for processor 709.

In an embodiment, computer platform 700 additionally or alternatively includes a data storage device 707 (e.g., a magnetic disk, optical disk, and/or other machine readable media) coupled to processor 709—e.g. via bus 701. Data storage device 707 may, for example, include instructions or other information to be operated on and/or otherwise accessed by processor 709. In an embodiment, processor 709 may generate image data based on a result of image recognition analysis stored in main memory 704, ROM 706, data storage device 707 or any other suitable data source.

Computer platform 700 may additionally or alternatively include a display device 721 for displaying information to a computer user. Display device 721 may, for example, include a frame buffer, a specialized graphics rendering device, a cathode ray tube (CRT), a flat panel display and/or the like. Additionally or alternatively, computer platform 700 may include an input device 722—e.g. including alphanumeric and/or other keys to receive user input. Additionally or alternatively, computer platform 700 may include a cursor control device 723, such as a mouse, a trackball, a pen, a touch screen, or cursor direction keys to communicate position, selection or other cursor information to processor 709, and/or to control cursor movement—e.g. on display device 721.

Computer platform 700 may additionally or alternatively have a hard copy device 724 such as a printer to print instructions, data, or other information on a medium such as paper, film, or similar types of media. Additionally or alternatively, computer platform 700 may include a sound record/playback device 725 such as a microphone or speaker to receive and/or output audio information. Computer platform 700 may additionally or alternatively include a digital video device 726 such as a still or motion camera to digitize an image representing a storage region of a commercial establishment.

In an embodiment, computer platform 700 includes or couples to a network interface 790 for connecting computer platform 700 to one or more networks (not shown)—e.g. including a dedicated storage area network (SAN), a local area network (LAN), a wide area network (WAN), a virtual LAN (VLAN), an Internet and/or the like. By way of illustration and not limitation, network interface 790 may include one or more of a network interface card (NIC), an antenna such as a dipole antenna, or a wireless transceiver, although the scope of certain embodiments are not limited in this respect.

Processor 709 may support instructions similar to those in any of a variety of conventional instruction sets—e.g. an instruction set which is compatible with the x86 instruction set used by existing processors. By way of illustration and not limitation, processor 709 may support operations corresponding to some or all operations supported in the IA™ Intel Architecture, as defined by Intel Corporation of Santa Clara, Calif. (see “IA-32 Intel® Architecture Software Developers Manual Volume 2: Instruction Set Reference,” Order Number 245471, available from Intel of Santa Clara, Calif. on the world wide web at developer.intel.com). As a result, processor 709 may support one or more operations corresponding, for example, to existing x86 operations, in addition to the operations of certain embodiments.

In one aspect, a method comprises receiving first image data representing an image of a storage region, the first image data comprising a first portion for a first area of the image and a second portion for a second area of the image. The method further includes detecting, based on an image recognition analysis of the first image data, a difference between a first state of inventory storage represented by the first area and a second state of inventory storage represented by the second area. The method further includes automatically generating second image data representing a modified version of the image, the generating including applying, based on the difference, a filter to only one of the first portion and the second portion.

In an embodiment, the detecting the difference includes detecting that the first area includes an indication of a first product type and that the second area does not include any indication of the first product type. In an embodiment, the detecting the difference includes detecting that the first area includes an indication of a first product type and that the second area includes an indication of a second product type.

In an embodiment, the detecting the difference is further based on a release rule indicating a conflict between the first product type and the second product type. In an embodiment, the conflict between the first product type and the second product type includes a conflict between a first commercial entity associated with the first product type and a second commercial entity associated with the second product type. In an embodiment, the detecting the difference includes detecting a failure of image recognition analysis to specify a state of inventory storage for the second area. In an embodiment, applying the filter is to provide a blurred representation of the second area in the modified version of the image. In an embodiment, applying the filter is to provide a masked representation of the second area in the modified version of the image. In an embodiment, applying the filter is to prevent any representation of the second area in the modified version of the image.

In another aspect, a computer-readable storage medium has stored thereon instructions which, when executed, cause a device to perform a method comprising receiving first image data representing an image of a storage region, the first image data comprising a first portion for a first area of the image and a second portion for a second area of the image. The method further includes detecting, based on an image recognition analysis of the first image data, a difference between a first state of inventory storage represented by the first area and a second state of inventory storage represented by the second area. The method further includes automatically generating second image data representing a modified version of the image, the generating including applying, based on the difference, a filter to only one of the first portion and the second portion.

In an embodiment, the method further comprises performing the image recognition analysis to generate image recognition information describing the first image data. In an embodiment, the detecting the difference includes detecting that the first area includes an indication of a first product type and that the second area does not include any indication of the first product type. In an embodiment, the detecting the difference includes detecting that the first area includes an indication of a first product type and that the second area includes an indication of a second product type. In an embodiment, the detecting the difference is further based on a release rule indicating a conflict between the first product type and the second product type. In an embodiment, the conflict between the first product type and the second product type includes a conflict between a first commercial entity associated with the first product type and a second commercial entity associated with the second product type. In an embodiment, the detecting the difference includes detecting a failure of image recognition analysis to specify a state of inventory storage for the second area.

In one aspect, an apparatus comprises an evaluation unit including circuit logic to receive first image data representing an image of a storage region, the first image data comprising a first portion for a first area of the image and a second portion for a second area of the image. The evaluation unit is further to detect, based on an image recognition analysis of the first image data, a difference between a first state of inventory storage represented by the first area and a second state of inventory storage represented by the second area. The apparatus further comprises a filter unit including circuit logic to automatically generate second image data representing a modified version of the image, including the filter unit to apply a filter, based on the difference, to only one of the first portion and the second portion.

In an embodiment, the evaluation unit is further to perform the image recognition analysis to generate image recognition information describing the first image data. In an embodiment, the evaluation unit to detect the difference includes the evaluation unit to detect that the first area includes an indication of a first product type and that the second area does not include any indication of the first product type. In an embodiment, the evaluation unit to detect the difference includes the evaluation unit to detect that the first area includes an indication of a first product type and that the second area includes an indication of a second product type. In an embodiment, the evaluation unit is to detect the difference is further based on a release rule indicating a conflict between the first product type and the second product type. In an embodiment, the conflict between the first product type and the second product type includes a conflict between a first commercial entity associated with the first product type and a second commercial entity associated with the second product type. In an embodiment, the evaluation unit to detect the difference includes the evaluation unit to detect a failure of image recognition analysis to specify a state of inventory storage for the second area.

In one aspect, a system comprises an image sensor device to generate first image data representing an image of a storage region, the first image data comprising a first portion for a first area of the image and a second portion for a second area of the image. The system further comprises a server coupled to the image sensor, the server including a network interface to receive the first image data from the image sensor and an evaluation unit including circuit logic to detect, based on an image recognition analysis of the first image data, a difference between a first state of inventory storage represented by the first area and a second state of inventory storage represented by the second area. The server further includes a filter unit including circuit logic to automatically generate second image data representing a modified version of the image, including the filter unit to apply a filter, based on the difference, to only one of the first portion and the second portion.

In an embodiment, the evaluation unit is further to perform the image recognition analysis to generate image recognition information describing the first image data. In an embodiment, the evaluation unit to detect the difference includes the evaluation unit to detect that the first area includes an indication of a first product type and that the second area does not include any indication of the first product type. In an embodiment, the evaluation unit to detect the difference includes the evaluation unit to detect that the first area includes an indication of a first product type and that the second area includes an indication of a second product type. In an embodiment, the evaluation unit is to detect the difference is further based on a release rule indicating a conflict between the first product type and the second product type. In an embodiment, the conflict between the first product type and the second product type includes a conflict between a first commercial entity associated with the first product type and a second commercial entity associated with the second product type. In an embodiment, the evaluation unit to detect the difference includes the evaluation unit to detect a failure of image recognition analysis to specify a state of inventory storage for the second area.

Techniques and architectures for providing image data are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of methods and symbolic representations of operations on data bits within a computer memory. These methods and representations are the means used by those skilled in the computing arts to most effectively convey the substance of their work to others skilled in the art. A method is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method operations. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A computer-readable storage medium having stored thereon instructions which, when executed, cause a device to perform a method comprising:
receiving first image data representing an image of a storage region, the first image data comprising a first portion for a first area of the image and a second portion for a second area of the image;
based on an image recognition analysis of the first image data, detecting a difference between a first state of inventory storage represented by the first area and a second state of inventory storage represented by the second area; and
automatically generating second image data representing a modified version of the image, the generating including:
based on the difference, applying a filter to only one of the first portion and the second portion.

2. The computer-readable storage medium of claim 1, the method further comprising performing the image recognition analysis to generate image recognition information describing the first image data.

3. The computer-readable storage medium of claim 1, wherein the detecting the difference includes detecting that the first area includes an indication of a first product type and that the second area does not include any indication of the first product type.

4. The computer-readable storage medium of claim 1, wherein the detecting the difference includes detecting that the first area includes an indication of a first product type and that the second area includes an indication of a second product type.

5. The computer-readable storage medium of claim 4, wherein the detecting the difference is further based on a release rule indicating a conflict between the first product type and the second product type.

6. The computer-readable storage medium of claim 5, wherein the conflict between the first product type and the second product type includes a conflict between a first commercial entity associated with the first product type and a second commercial entity associated with the second product type.

7. The computer-readable storage medium of claim 1, wherein the detecting the difference includes detecting a failure of image recognition analysis to specify a state of inventory storage for the second area.

8. An apparatus comprising:
an evaluation unit including circuit logic to receive first image data representing an image of a storage region, the first image data comprising a first portion for a first area of the image and a second portion for a second area of the image, the evaluation unit further to detect, based on an image recognition analysis of the first image data, a difference between a first state of inventory storage represented by the first area and a second state of inventory storage represented by the second area; and
a filter unit including circuit logic to automatically generate second image data representing a modified version of the image, including the filter unit to apply a filter, based on the difference, to only one of the first portion and the second portion.

9. The apparatus of claim 8, the evaluation unit further to perform the image recognition analysis to generate image recognition information describing the first image data.

10. The apparatus of claim 8, wherein the evaluation unit to detect the difference includes the evaluation unit to detect that the first area includes an indication of a first product type and that the second area does not include any indication of the first product type.

11. The apparatus of claim 8, wherein the evaluation unit to detect the difference includes the evaluation unit to detect that the first area includes an indication of a first product type and that the second area includes an indication of a second product type.

12. The apparatus of claim 11, wherein the evaluation unit to detect the difference is further based on a release rule indicating a conflict between the first product type and the second product type.

13. The apparatus of claim 12, wherein the conflict between the first product type and the second product type includes a conflict between a first commercial entity associated with the first product type and a second commercial entity associated with the second product type.

14. The apparatus of claim 8, wherein the evaluation unit to detect the difference includes the evaluation unit to detect a failure of image recognition analysis to specify a state of inventory storage for the second area.

15. A system comprising:
an image sensor device to generate first image data representing an image of a storage region, the first image data comprising a first portion for a first area of the image and a second portion for a second area of the image; and
a server coupled to the image sensor, the server including:
a network interface to receive the first image data from the image sensor;
an evaluation unit including circuit logic to detect, based on an image recognition analysis of the first image data, a difference between a first state of inventory storage represented by the first area and a second state of inventory storage represented by the second area; and
a filter unit including circuit logic to automatically generate second image data representing a modified version of the image, including the filter unit to apply a filter, based on the difference, to only one of the first portion and the second portion.

16. The system of claim 15, the evaluation unit further to perform the image recognition analysis to generate image recognition information describing the first image data.

17. The system of claim 15, wherein the evaluation unit to detect the difference includes the evaluation unit to detect that the first area includes an indication of a first product type and that the second area does not include any indication of the first product type.

18. The system of claim 15, wherein the evaluation unit to detect the difference includes the evaluation unit to detect that the first area includes an indication of a first product type and that the second area includes an indication of a second product type.

19. The system of claim 18, wherein the evaluation unit to detect the difference is further based on a release rule indicating a conflict between the first product type and the second product type.

20. The system of claim 19, wherein the conflict between the first product type and the second product type includes a conflict between a first commercial entity associated with the first product type and a second commercial entity associated with the second product type.

21. The system of claim 15, wherein the evaluation unit to detect the difference includes the evaluation unit to detect a failure of image recognition analysis to specify a state of inventory storage for the second area.

22. A method comprising:
receiving first image data representing an image of a storage region, the first image data comprising a first portion for a first area of the image and a second portion for a second area of the image;
based on an image recognition analysis of the first image data, detecting a difference between a first state of inventory storage represented by the first area and a second state of inventory storage represented by the second area; and
automatically generating second image data representing a modified version of the image, the generating including:
based on the difference, applying a filter to only one of the first portion and the second portion.

23. The method of claim 22, wherein the detecting the difference includes detecting that the first area includes an indication of a first product type and that the second area does not include any indication of the first product type.

24. The method of claim 22, wherein the detecting the difference includes detecting that the first area includes an indication of a first product type and that the second area includes an indication of a second product type.

25. The method of claim 22, wherein the detecting the difference is further based on a release rule indicating a conflict between the first product type and the second product type.

26. The method of claim 25, wherein the conflict between the first product type and the second product type includes a conflict between a first commercial entity associated with the first product type and a second commercial entity associated with the second product type.

27. The method of claim 22, wherein the detecting the difference includes detecting a failure of image recognition analysis to specify a state of inventory storage for the second area.

28. The method of claim 22, wherein applying the filter is to provide a blurred representation of the second area in the modified version of the image.

29. The method of claim 22, wherein applying the filter is to provide a masked representation of the second area in the modified version of the image.

30. The method of claim 22, wherein applying the filter is to prevent any representation of the second area in the modified version of the image.
